(19) United States
(12) Patent Application Publication
(10) Pub. No.: US 2014/0049688 A1
(43) Pub. Date: Feb. 20, 2014

(54) IMAGING APPARATUS

(71) Applicant: SONY CORPORATION, Tokyo (JP)

(72) Inventors: Yusuke Ohnishi, Kanagawa (JP); Tsuyoshi Kanai, Tokyo (JP); Tamaki Watanabe, Kanagawa (JP); Masashi Jimbo, Tokyo (JP)

(73) Assignee: SONY CORPORATION, Tokyo (JP)

(21) Appl. No.: 13/954,047

(22) Filed: Jul. 30, 2013

(30) Foreign Application Priority Data
Aug. 16, 2012 (JP) 2012-180628

(51) Int. Cl. H04N 5/225

(52) U.S. Cl. CPC H04N 5/2252
USPC 348/375

(57) ABSTRACT

An imaging apparatus including: an imaging apparatus body; a photographing lens provided in the imaging apparatus body; a shoulder pad which is slidably provided in the imaging apparatus body in a direction opposite to a direction in which the photographing lens is provided; and an accessory mounting section which is provided in the shoulder pad and is capable of mounting an accessory.

### BACKGROUND

The present technology relates to an imaging apparatus. There is an imaging apparatus which is relatively large in the size and heavy in the weight such as a television broadcasting camera or a professional camera, in which a shoulder pad is provided on a bottom surface of the imaging apparatus so as to be used when photographing by carrying the imaging apparatus on shoulder (Japanese Unexamined Patent Application Publication No. 2012-95028).

### SUMMARY

However, in the imaging apparatus disclosed in Japanese Unexamined Patent Application Publication No. 2012-95028, a user can put the imaging apparatus on his shoulder by having a shoulder pad thereof; however, it is not intended to improve the balance thereof when using the imaging apparatus. Since the imaging apparatus includes a heavy lens in the front thereof, the balance is lost and the stability is deteriorated when using the imaging apparatus. In addition, in the imaging apparatus disclosed in Japanese Unexamined Patent Application Publication No. 2012-95028, since a so-called shoulder style photographing is assumed which performs the photographing by carrying the imaging apparatus on the shoulder, it is not possible to achieve both the shoulder style and a handy style in which the photographing is performed by holding the imaging apparatus with a hand.

The technology has been made in view of such problems and it is desirable to provide an imaging apparatus which can improve the stability when using the imaging apparatus and achieve both a shoulder style and a handy style.

According to an embodiment of the present technology, there is provided an imaging apparatus including: an imaging apparatus body; a photographing lens provided in the imaging apparatus body; a shoulder pad which is slidably provided in the imaging apparatus body in a direction opposite to a direction in which the photographing lens is provided; and an accessory mounting section which is provided in the shoulder pad and is capable of mounting an accessory.

According to an embodiment of the present technology, the stability can be improved when using the imaging apparatus and both the shoulder style and the handy style can be achieved.

### BRIEF DESCRIPTION OF THE DRAWINGS

FIG. 1A is an external perspective view of an imaging apparatus when a shoulder pad is stored and FIG. 1B is an external perspective view of the imaging apparatus when the shoulder pad is slid;

FIG. 2A is a left side view of the imaging apparatus and FIG. 2B is a right side view of the imaging apparatus;

FIG. 3A is a front view of the imaging apparatus and FIG. 3B is a rear view of the imaging apparatus;

FIG. 4A is an upper perspective view illustrating a slide mechanism when the shoulder pad is stored and FIG. 4B is an upper perspective view illustrating the slide mechanism when the shoulder pad is slid;

FIG. 5A is a lower perspective view illustrating the slide mechanism in a state where slide of the shoulder pad is locked and FIG. 5B is a lower perspective view illustrating the slide mechanism in a state where the slide of the shoulder pad is unlocked;

FIG. 6 is an exploded view of the slide mechanism;

FIG. 7 is a view illustrating a configuration of a slider of the slide mechanism;

FIG. 8A is a lower perspective view illustrating a configuration of a lock mechanism in a locked state and FIG. 8B is a lower perspective view illustrating the configuration of the lock mechanism in an unlocked state;

FIG. 9A is a cross-sectional view of the lock mechanism in the locked state and FIG. 9B is a side view of the lock mechanism in the locked state;

FIG. 10A is a cross-sectional view of the lock mechanism in the unlocked state and FIG. 10B is a side view of the lock mechanism in the unlocked state; and

FIG. 11 is an external perspective view illustrating a modification example of the imaging apparatus of an embodiment of the present technology.

### DETAILED DESCRIPTION OF EMBODIMENTS

Hereinafter, an embodiment of the technology is described with reference to the drawings. In addition, the description thereof is given in the following order:

### 1. Embodiment

### 1-1. Configuration of Imaging Apparatus

### 1-2. Configuration of Slide Mechanism

### 1-3. Configuration of Lock Mechanism

### 2. Modification Example

### 1. Embodiment

### 1-1. Configuration of Imaging Apparatus

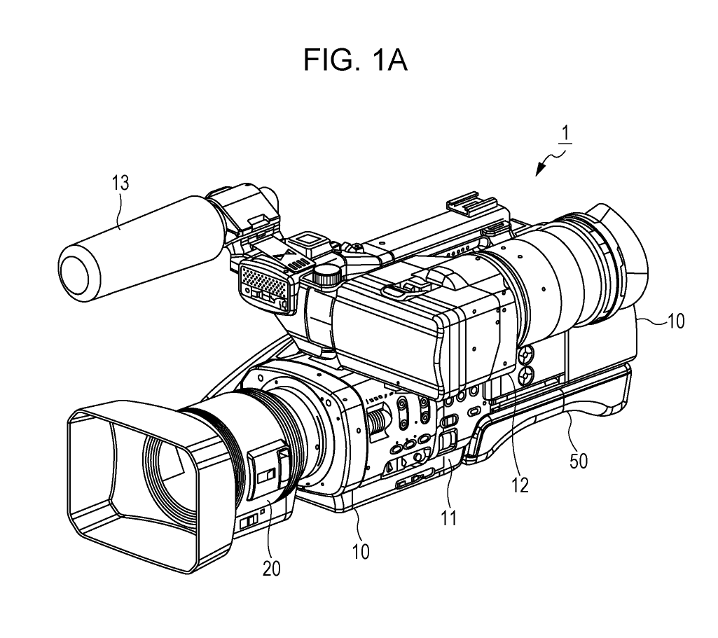

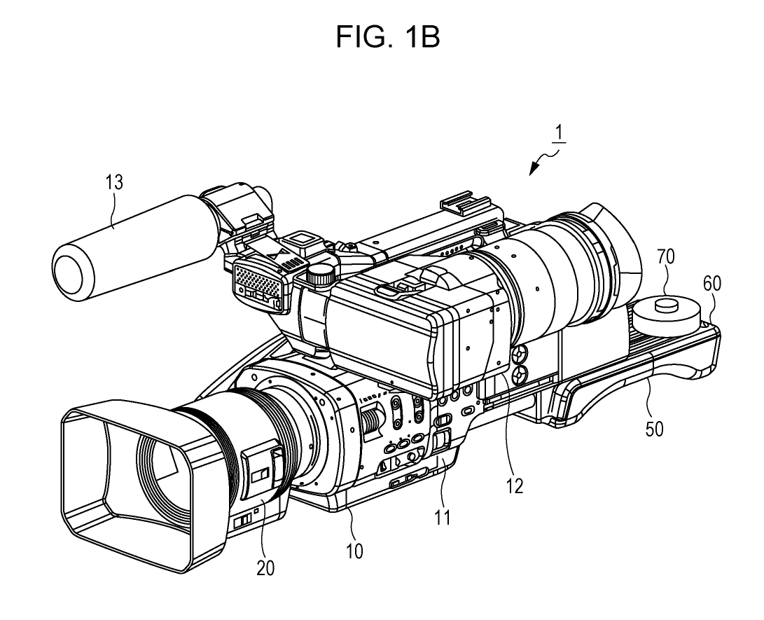

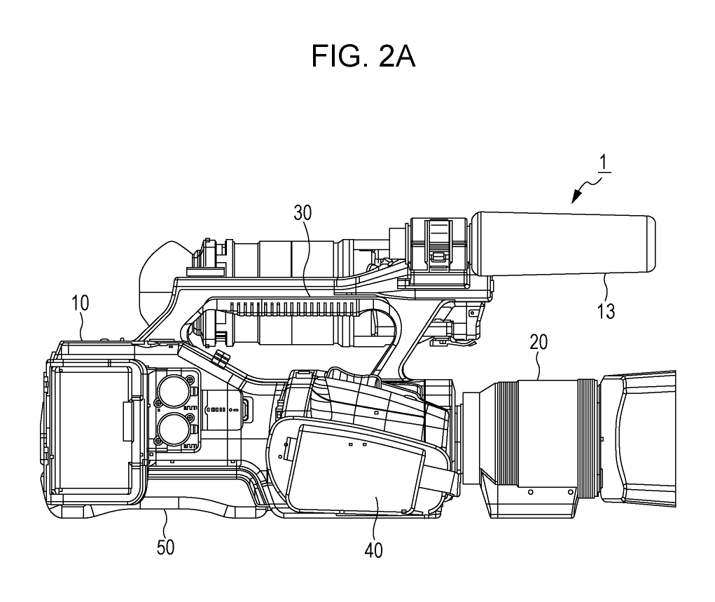

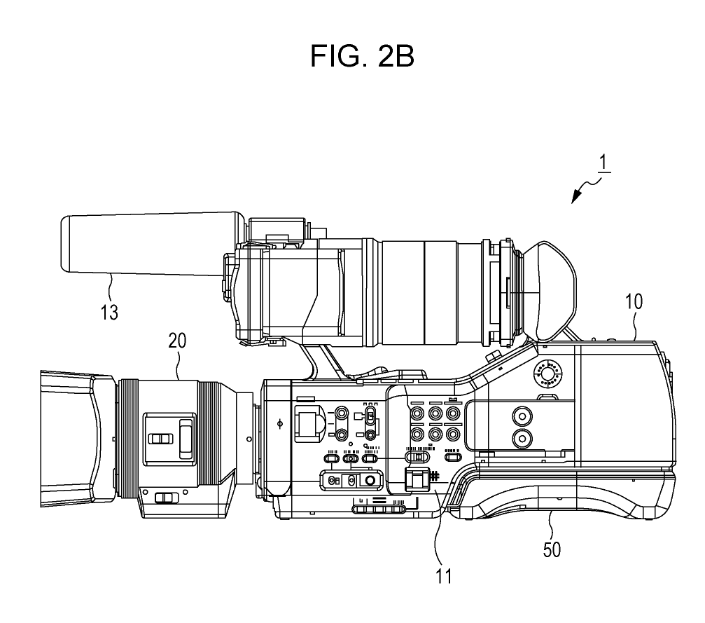

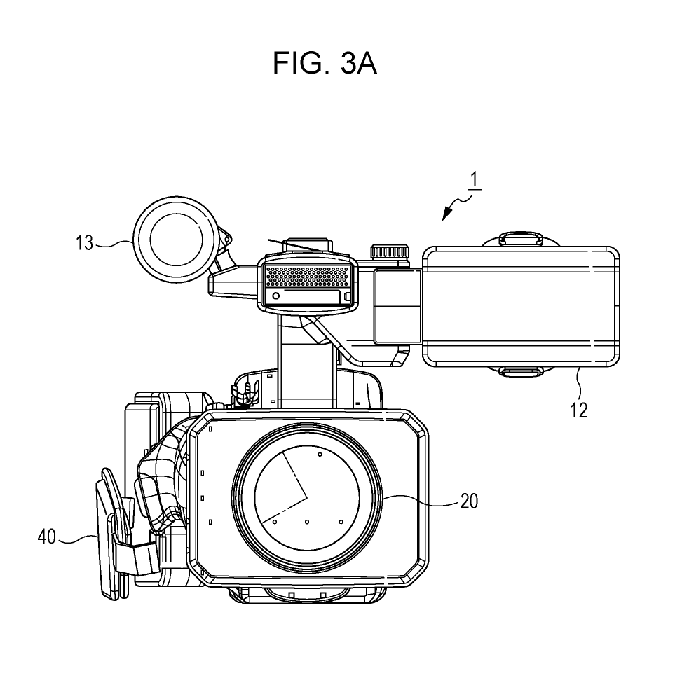

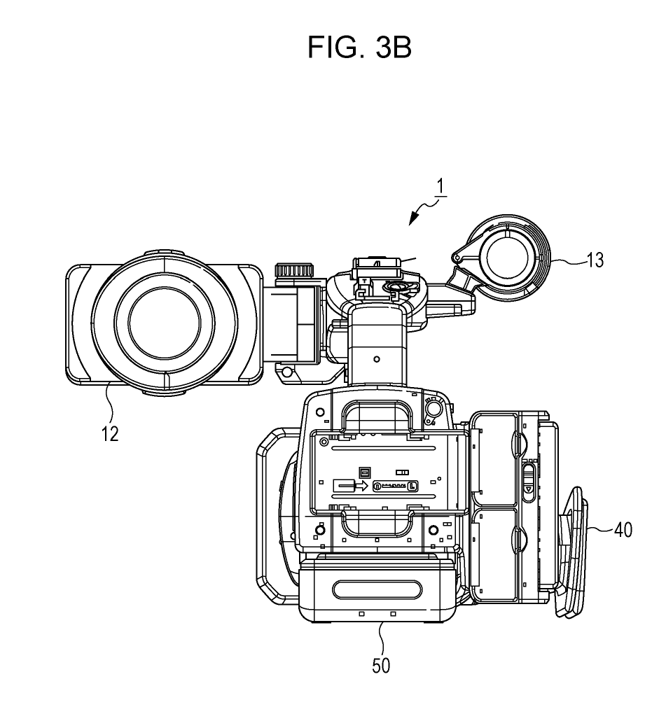

FIG. 1A is a perspective view of an external configuration of an imaging apparatus 1 when a shoulder pad 50 is stored and FIG. 1B is a perspective view of the external configuration of the imaging apparatus 1 when the shoulder pad 50 is slid. In addition, FIG. 2A is a left side view of the imaging apparatus and FIG. 2B is a right side view of the imaging apparatus. Furthermore, FIG. 3A is a front view of the imaging apparatus and FIG. 3B is a rear view of the imaging apparatus.

The imaging apparatus 1 includes an imaging apparatus body 10, a photographing lens 20, a second grip section 30, a first grip section 40, a shoulder pad 50 and an accessory mounting section 60. In addition, the imaging apparatus body 10 includes an input section 11, a display section 12, a microphone 13 and the like.

The imaging apparatus 1 can take a so-called handy style photographing by grasping a grip with a hand and can take a so-called shoulder style photographing by carrying the imaging apparatus on a shoulder. In a case of the handy style, the imaging apparatus 1 is held and the photographing is performed by grasping the first grip section 40 or the second grip section 30 with a hand. In a case of the shoulder style, the photographing is performed in a state where the imaging apparatus 1 is supported by placing the shoulder pad 50 on the shoulder and by attaching one hand in the first grip section 40.

The imaging apparatus body 10 includes, inside thereof, an imaging device such as a charge coupled device (CCD) and a complementary metal oxide semiconductor (CMOS), various process circuits for image processing and for voice processing, a control section which controls the entire imaging apparatus 1, a storage section such as a hard disk drive and a flash memory, a battery or the like. The imaging device in the imaging apparatus body 10 converts object light focused by the photographing lens 20 into an image signal and each of various process circuits performs a predetermined image process on the image signal. Then, finally, a photographed image is stored in a storage section.

The photographing lens 20 is a so-called interchangeable lens which is, for example, detachably configured in the imaging apparatus body 10. The photographing lens 20 is intended to focus the light from the object on the imaging device in the imaging apparatus body 10. The photographing lens 20 may include a driving mechanism which performs focusing or zooming by moving the photographing lens 20, a shutter mechanism and an iris mechanism. Those mechanisms are driven based on the control signal from the control section of the imaging apparatus 1.

The input section 11 is formed of buttons and the like to perform various operations of the imaging apparatus 1. The input section 11 includes a power button for switching the power ON/OFF, a button for switching AUTO/MANUAL, a START/STOP button for video photographing, a button for still photographing, a button for IRIS, a button for FOCUS, a menu button for various settings and the like, a zoom lever for zoom adjustment, a dial for audio adjustment and the like. When input is made in the input section 11, the control signal is generated according to the input and is output to the control section, various processing circuits and the like in the imaging apparatus body 10. Then, the imaging apparatus 1 performs calculation process or control corresponding to the control signal thereof.

The display section 12 is a display unit which is configured of, for example, a liquid crystal display (LCD), a plasma display panel (PDP), an organic electro luminescence (EL) panel and the like. The display section 12 functions as a viewfinder by displaying the video in photographing. In addition, the display section 12 functions as a unit for displaying the video which is photographed and recorded in the storage section.

The microphone 13 is for collecting sound in photographing and the voice which is input into the microphone 13 is supplied to the processing circuit and the like in the imaging apparatus body 10 by being converted to an audio signal and is stored as audio data.

The second grip section 30 is provided on an upper surface of the imaging apparatus body 10. A user can stably perform the photographing by grasping the second grip section 30, for example, when the object is photographed in a low position or the like.

In addition, the first grip section 40 is provided on a side surface of the imaging apparatus body 10. The user can stably support the imaging apparatus 1 and can perform the photographing for a long time by using the first grip section 40 in a state where the imaging apparatus 1 is stably carried by placing the shoulder pad 50 on the shoulder. In addition, the first grip section 40 is also used in the handy style.

The shoulder pad 50 is slidably provided on a bottom surface side of the imaging apparatus body 10 in a longitudinal direction of the imaging apparatus 1 by the slide mechanism. The configuration of the slide mechanism is described below.

The user carries the imaging apparatus 1 on the shoulder by placing the shoulder pad 50 on the shoulder and stably performs the photographing by using the first grip section 40 when the photographing is performed using the imaging apparatus 1. Therefore, the photographing can be performed for a long time even though the imaging apparatus 1 is heavy. In order to reduce the burden on the shoulder of the user, the shoulder pad 50 may be, for example, configured of a resilient material such as urethane foam, cotton and chemical fiber covered by cloth, synthetic leather and the like. However, the configuration of the shoulder pad 50 is not limited to the embodiment and may be configured of plastic and the like.

The accessory mounting section 60 is provided on the upper surface side of the shoulder pad 50. The accessory mounting section 60 is, for example, configured of a fixing hole capable of fixing the accessory. The fixing hole is provided substantially at the center of the upper surface side of the shoulder pad 50. A fixing method of the accessory includes, for example, fixing by screw. In this case, the fixing hole is configured of a screw hole. In addition, as illustrated in FIGS. 1A and 1B, the accessory mounting section 60 is hid in the bottom surface of the imaging apparatus body 10 when the shoulder pad 50 is stored.

The accessory mounted on the accessory mounting section 60 may be, for example, a weight. In FIG. 1B, the weight is mounted as an accessory 70. Since the imaging apparatus 1 includes the heavy photographing lens 20 in the front thereof, the balance thereof is collapsed and the stability is deteriorated when using the imaging apparatus 1. Then, the balance of the imaging apparatus 1 can be improved and the stability thereof can be increased by mounting the weight on the accessory mounting section 60 in the rear of the imaging apparatus 1. In addition, when a plurality of the screw holes are provided as the accessory mounting section 60 in a slide direction (a longitudinal direction of the imaging apparatus 1) of the shoulder pad 50, a mounting position of the weight can be selected from the holes. Therefore, adjustment of the balance can be performed with a more accurate weight by arbitrarily selecting the mounting position of the accessory according to a user's preference, the physical size and physical characteristics of the user, a weight of the accessory or the like.

In addition, other examples of the accessory may include an external monitor, an external recorder, a spare battery, a projector, a separate imaging apparatus and the like. A person in addition to the user who performs the photographing can check the photographed video in real time by being providing the external monitor as the accessory and by displaying the current photographing video on the external monitor.

When the external recorder is provided as the accessory, the recording can be performed for a longer additional time for the storage section in the imaging apparatus body 10. In addition, when the spare battery is provided as the accessory, it is possible to respond even when the battery in the imaging apparatus body 10 is dead. In addition, when the projector is provided as the accessory, the current photographed video is projected on a rear wall of the user who performs the photographing, on a screen or the like with the projector thereof and then a person in addition to the user can check the photographed video with larger video display in real time. Furthermore, it is possible to perform more diversified photographing by providing the separate imaging apparatus 1 as the accessory. As described above, when the device such as the external monitor, the external recorder, the projector and the separate imaging apparatus 1 is mounted as the accessory, the device can be used by connecting the device to an external output terminal or the like included in the imaging apparatus 1.

As described above, function of the imaging apparatus 1 can be easily expanded by mounting various devices as the accessory. In addition, the mounting method of the accessory is not limited to the screwing method and may include any method as long as the accessory can be stably mounted. For example, it may be a structure in which the accessory is mounted on a tripod-seat.

### 1-2. Configuration of Slide Mechanism

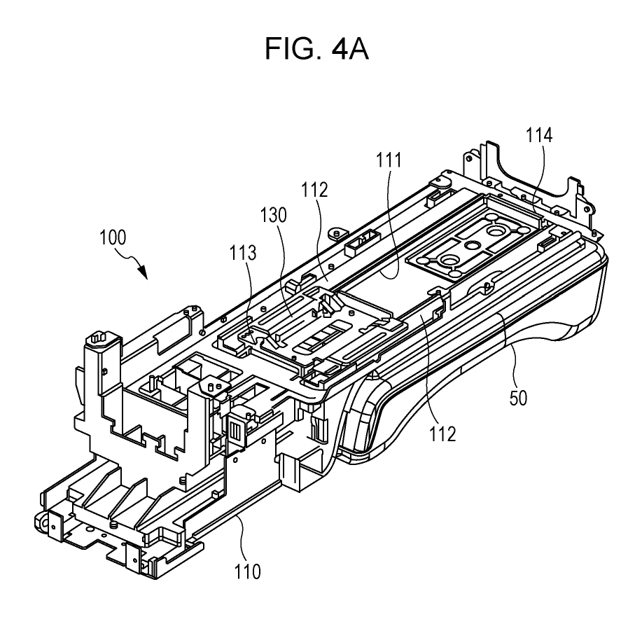

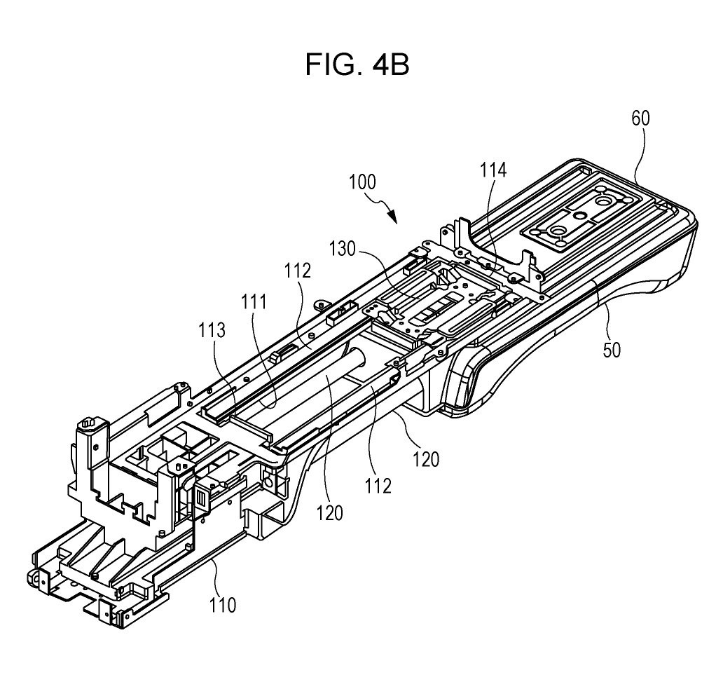

Next, a configuration of a slide mechanism 100 sliding on the shoulder pad 50 is described. FIGS. 4A and 4B are upper perspective views illustrating the configuration of the slide mechanism 100 by which the shoulder pad 50 is slid.

FIG. 4A illustrates the configuration thereof when the shoulder pad 50 is stored and FIG. 4B illustrates the configuration thereof when the shoulder pad 50 is slid.

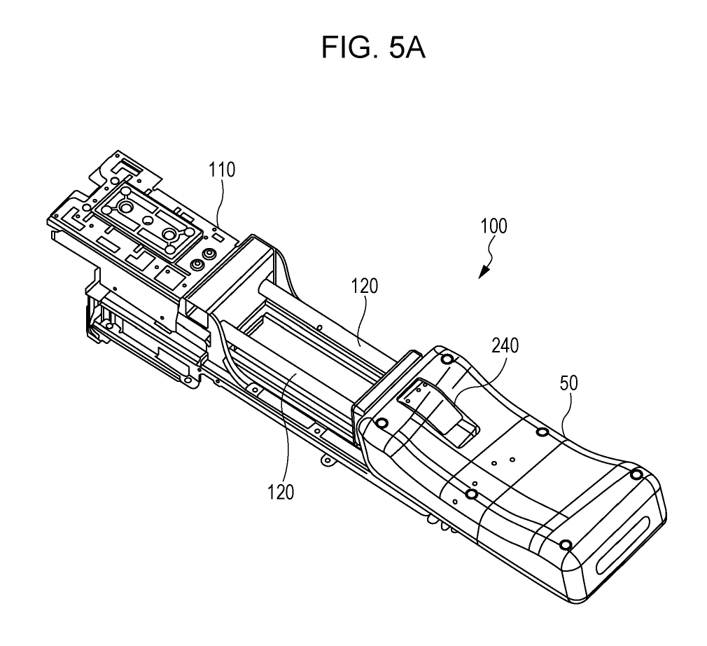

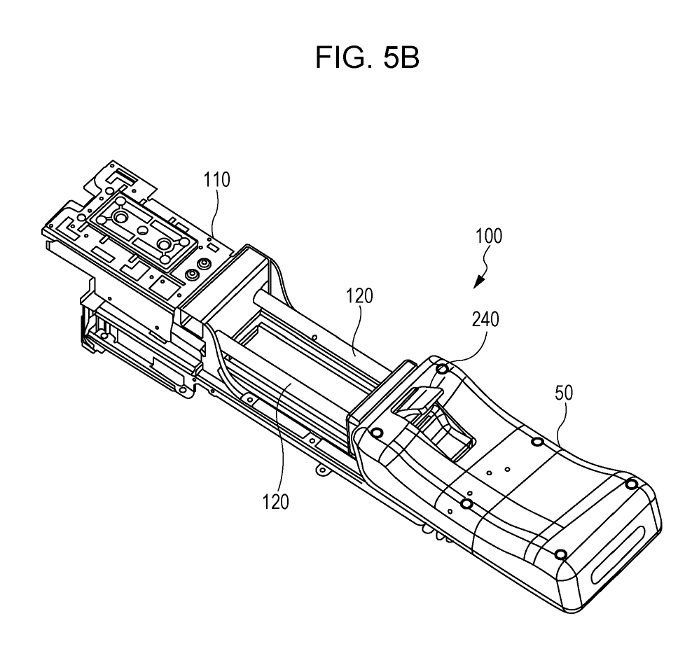

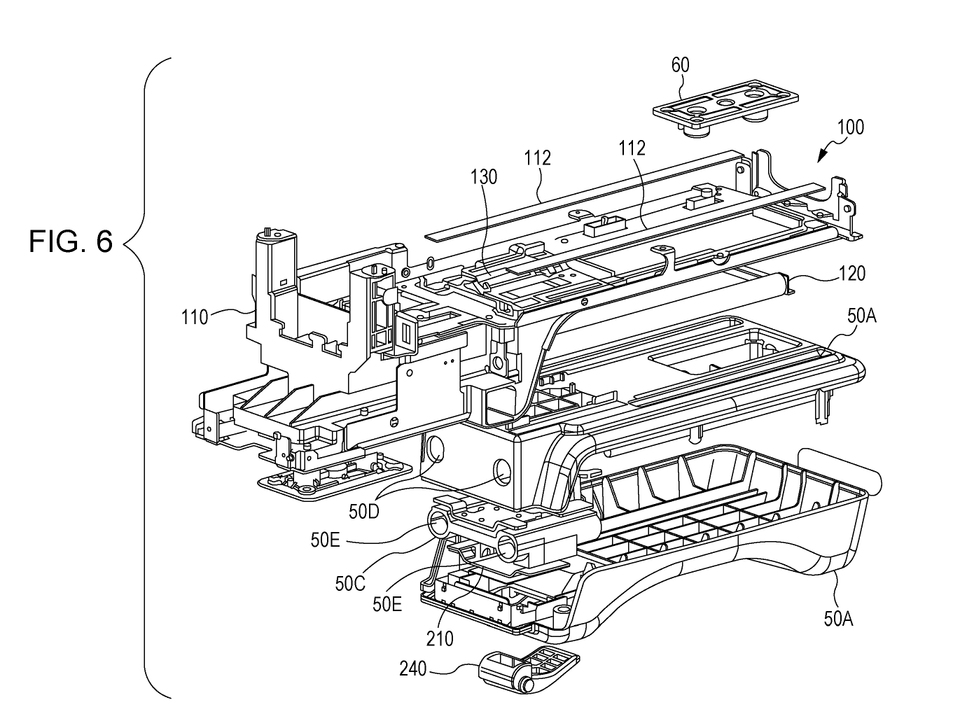

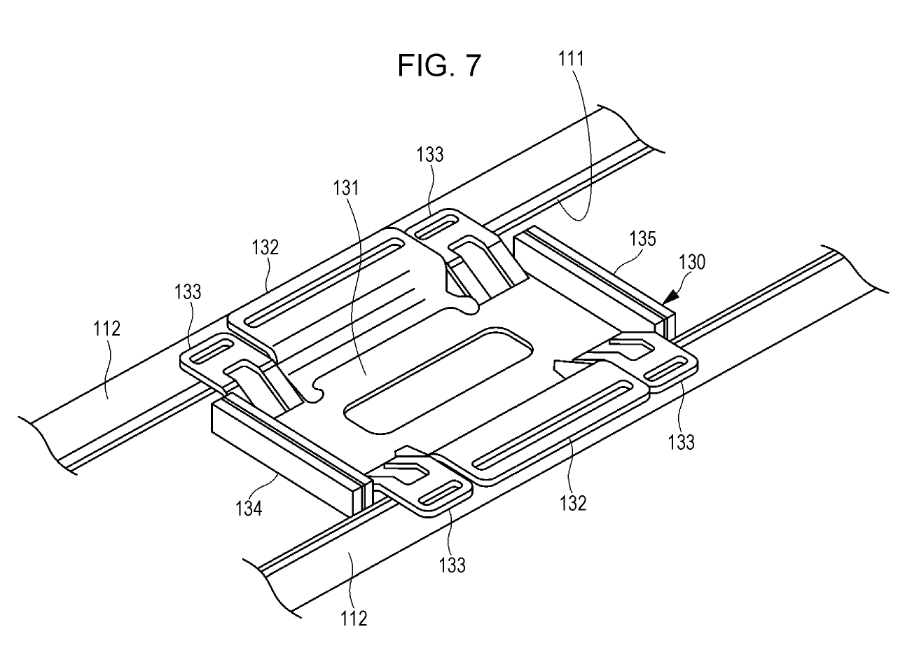

FIGS. 5A and 5B are lower perspective views illustrating the slide mechanism 100. In addition, FIG. 6 is an exploded view of the slide mechanism 100. Furthermore, FIG. 7 is a view illustrating a slider 130 configuring the slide mechanism 100.

The slide mechanism 100 is configured of a base body 110, two guide shafts 120 and 120 and the slider 130. The base body 110 is formed of, for example, plastic or the like and is coupled to the imaging apparatus body 10 in the lower part of the imaging apparatus body 10 of the imaging apparatus 1. The base body 110 is coupled to the imaging apparatus body 10 by, for example, a bolt and nut.

A substantially rectangular shaped slider groove 111 is formed in the base body 110 along the longitudinal direction thereof. In addition, linear slider receiving sections 112 and 112 are formed on both end sides of the slider groove 111 in the longitudinal direction thereof. The slider 130 slides along the slider groove 111 while engaging in the slider receiving section 112.

A protruding shaped first stopper receiving section 113 standing upward is provided on one end side of the slider groove 111 in the longitudinal direction thereof. The first stopper receiving section 113 regulates the slide of the slider 130 by abutting with a first stopper section 134 included in the slider 130 when the slider 130 is slid in a storing direction.

A protruding shaped second stopper receiving section 114 standing upward is provided on the other end side of the slider groove 111 in the longitudinal direction thereof. The second stopper receiving section 114 regulates the slide of the slider 130 at a limited position of the slider by abutting with a second stopper section 135 included in the slider 130 when the slider 130 is slid in a direction opposite to the mounting direction of the photographing lens 20 of the imaging apparatus 1.

Two guide shafts 120 are provided to extend in a direction opposite to the direction in which the photographing lens 20 is provided in the imaging apparatus body 10 along the longitudinal direction of the base body 110. The guide shaft 120 regulates the slide of the shoulder pad 50 in one direction and is intended to be able to stably slide the shoulder pad 50 by inserting through the shoulder pad 50. The number of the guide shaft 120 is one; however, the shoulder pad 50 can be more stably slid by providing two guide shafts 120.

As illustrated in FIG. 6, the shoulder pad 50 is configured of, inside thereof, an upper case 50A, a pad section 50B and a shoulder pad supporting section 50C. The shoulder pad 50 is configured by coupling the upper case 50A and the pad section 50B so as to include the shoulder pad supporting section 50C inside thereof. The upper case 50A has inserting holes 50D and 50D for inserting the guide shafts 120. In addition, the shoulder pad supporting section 50C has inserting holes 50E and 50E for inserting the guide shafts 120. The guide shaft 120 is inserted through the inserting hole 50D and the inserting hole 50E thereby slidably supporting the shoulder pad 50.

The slider 130 is connected to the upper case 50A of the shoulder pad 50 and is intended to slide the shoulder pad 50 along the longitudinal direction of the imaging apparatus body 10 by sliding along the slider groove 111 of the base body 110. The slider 130 includes a slider body 131, L-shaped protrusion sections 132 and 132, the first stopper section 134, and the second stopper section 135. Furthermore, the slider body 131 of the slider 130 has leaf spring sections 133, 133 . . . , configured of separate members.

The slider body 131 of the slider 130 is formed in a substantially flat plate shape. The L-shaped protrusion sections 132 and 132, which have predetermined widths and are protrusions having substantially L-shape in a front view, are provided at both right and left ends of the slider body 131. The L-shaped protrusion section 132 is configured to be opposite to the slider receiving sections 112 and 112 at both ends of the slider groove 111 of the base body 110. The L-shaped protrusion sections 132 and 132 do not come into contact with the slider receiving sections 112 and 112 of the base body 110 when the shoulder pad 50 is slid and the function is for receiving impact when the imaging apparatus 1 is dropped in the slide state.

In addition, the slider body 131 has the leaf spring sections 133, 133 . . . . The leaf spring section 133 is configured to be caught by the slider receiving section 112 of the base body 110. The leaf spring section 133 presses the slider receiving section 112 with an elastic force and thereby generating a frictional force. Accordingly, a sliding speed of the slider 130 becomes an appropriate speed.

The first stopper section 134 is a protrusion standing upward from a front end of the slider body 131. The first stopper section 134 stops the slide of the slider 130 and the shoulder pad 50 by coming into contact with the first stopper receiving section 113 of the base body 110. The second stopper section 135 is a protrusion standing upward from a rear end of the slider body 131. The second stopper section 135 stops the slide of the slider 130 and the shoulder pad 50 by coming into contact with the second stopper receiving section 114 of the base body 110.

### 1-3. Configuration of Lock Mechanism

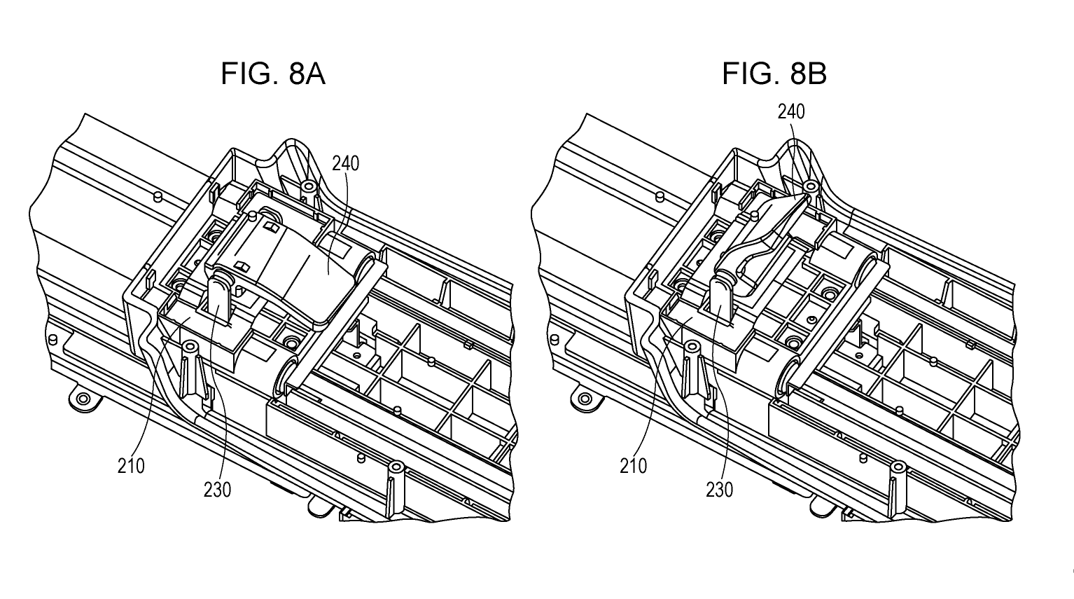

Next, a configuration of a lock mechanism 200 is described. FIGS. 8A and 8B are lower perspective views illustrating the configuration of the lock mechanism 200 which locks the slide of the shoulder pad 50. FIG. 8A illustrates a locked state and FIG. 8B illustrates an unlocked state.

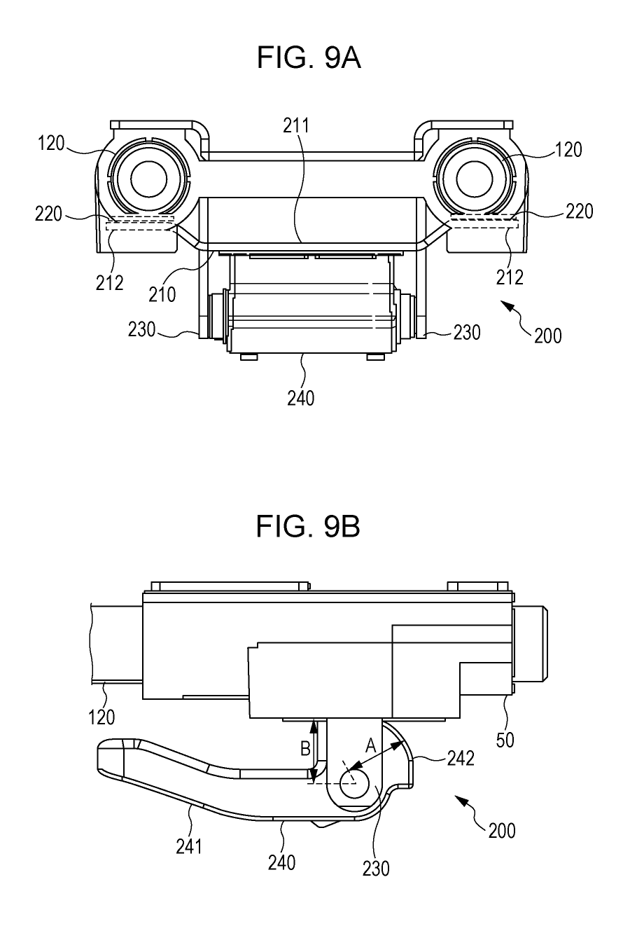

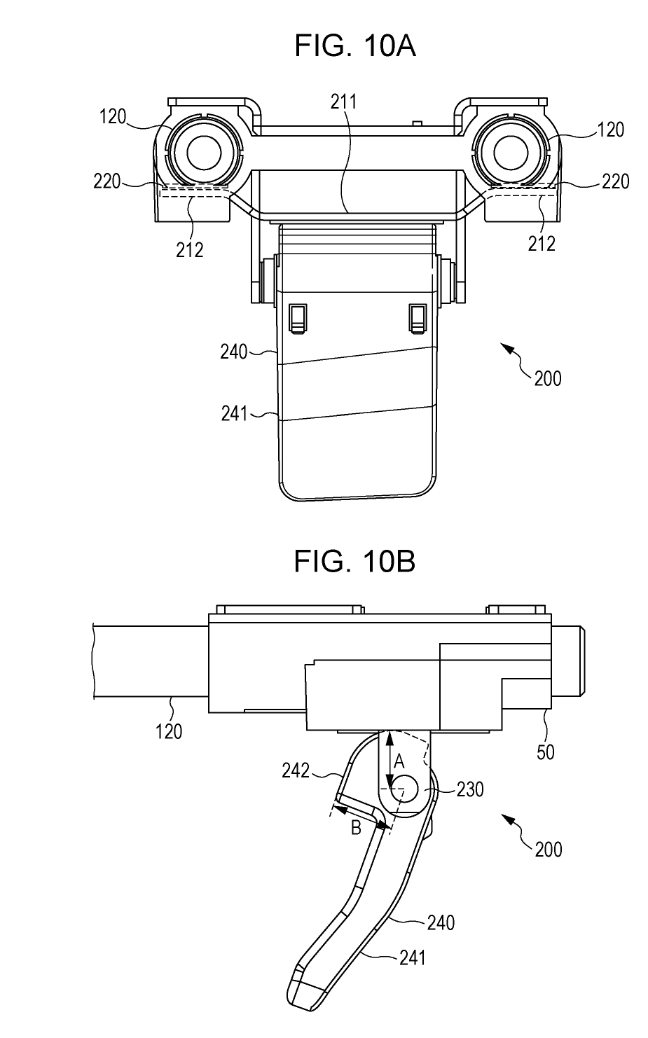

In addition, FIG. 9A is a cross-sectional view illustrating the locked state of the lock mechanism 200 and FIG. 9B is a side view illustrating the locked state of the lock mechanism 200. FIG. 10A is a cross-sectional view illustrating the unlocked state of the lock mechanism 200 and the FIG. 10B is a side view illustrating the unlocked state of the lock mechanism 200.

The lock mechanism 200 is configured of a lock plate 210, a lock seat 220, a lever supporting section 230 and a lock lever 240.

The lock plate 210 is configured of a lever contact section 211 at the center thereof and shaft pressing sections 212 formed at both ends of the lever contact section 211. The lever contact section 211 is pressed by a pressing section 242 of the lock lever 240 when being locked. The shaft pressing sections 212 are intended to regulate the slide operation of the slider 130 and the shoulder pad 50 by pressing the guide shaft 120 when being locked.

The lock seat 220 is attached to the shaft pressing sections 212 of the lock plate 210 so as to be interposed between the shaft pressing section 212 of the lock plate 210 and the guide shaft 120. Accordingly, the lock seat 220 comes into contact with the guide shaft 120 in the locked state. The lock seat 220 is formed of, for example, a synthetic resin such as plastic and rubber to have a predetermined frictional force.

The lock lever 240 is configured of an operation lever section 241 for the user to operate with a hand and the pressing section 242 positioned on one end side of the operation lever section 241. The lock lever 240 is rotatably provided by being supported on a rotation shaft passing through the lever supporting section 230 and the pressing section 242 between a pair of the lever supporting sections 230.

The pressing section 242 is intended for the slider 130 to be the locked state by pressing the lever contact section 211 of the lock plate 210. In the embodiment, the lock lever 240 is configured such that a state where the lock lever 240 is overturned is the locked state and a state where the lock lever 240 is stood is the unlocked state.

The pressing section 242 of the lock lever 240 is configured such that when the lock lever 240 is in the vertical state, a surface of the pressing section 242 of the lock lever 240 facing the lock plate 210 does not come into contact with the lock plate 210 and when the lock lever 240 is in the overturned state, the surface facing the lock plate 210 presses the lock plate 210 by coming into contact with the lock plate 210.

In other words, the pressing section 242 of the lock lever 240 is configured such that a distance B from the surface facing the lock plate 210 to a rotation center when the lock lever 240 is in the overturned state is longer than a distance A from the surface facing the lock plate 210 to the rotation center when the lock lever 240 is in the vertical state.

The lock mechanism 200 is configured as described above. Next, operation of locking and unlocking by the lock mechanism 200 is described. Firstly, when the lock lever 240 is in the vertical state as illustrated in FIGS. 10A and 10B, the lock is released and the shoulder pad 50 is in a slidable state. In this state, the user can move the shoulder pad 50 to any position.

Then, when the position of the shoulder pad 50 is determined, the shoulder pad 50 is locked at the position by the lock mechanism 200. In order to lock the shoulder pad 50, firstly, the operation lever section 241 of the lock lever 240 is operated and then the lock lever 240 is in the overturned state. Then, the pressing section 242 of the lock lever 240 presses the lever contact section 211 of the lock plate 210. Therefore, the lock plate 210 is bent and then the shaft pressing sections 212 of the lock plate 210 presses the guide shaft 120 via the lock seat 220.

Accordingly, a large frictional force is generated between the guide shaft 120 and the lock seat 220, and the slide of the slider 130 is regulated by the frictional force. This state is the locked state. The user can make the position of the shoulder pad 50 be stabilized at any position by locking the slide of the slider 130. Then, the imaging apparatus 1 is carried by placing the shoulder pad 50 on the shoulder and the photographing can be stably performed by supporting the imaging apparatus 1 using the first grip section 40 with one hand.

When the position of the shoulder pad 50 is further changed or when the shoulder pad 50 is stored, the locked state is released. In order to release the locked state, the lock lever 240 is in the vertical state. As described above, the pressing section 242 of the lock lever 240 is configured such that when the lock lever 240 is in the overturned state, the surface of the pressing section 242 of the lock lever 240 facing the lock plate 210 comes into contact with the lock plate 210 and when the lock lever 240 is in the vertical state, the surface facing the lock plate 210 does not comes into contact with the lock plate 210. Therefore, when the lock lever 240 is in the vertical state, the pressing section 242 of the lock lever 240 is separated from the lock plate 210 and the pressing state of the guide shaft 120 against the lock plate 210 is released. Accordingly, the friction between the lock seat 220 and the guide shaft 120 does not exist, and the slider 130 and the shoulder pad 50 are capable of sliding.

When the shoulder pad 50 is capable of sliding, the user makes the shoulder pad 50 be slid to any position. Otherwise, the shoulder pad 50 is slid to the storage position. Then, when the position of the shoulder pad 50 is determined, or when the shoulder pad 50 is slid to the storage position, the lock lever 240 is overturned thereby being the locked state as described above.

When the shoulder pad 50 is slid, the accessory mounting section 60 provided on the upper surface of the shoulder pad 50 appears. When the user further performs the adjustment of the balance of the imaging apparatus 1 in addition to the slide of the shoulder pad 50, the user mounts the weight on the accessory mounting section 60. Therefore, the adjustment of the balance can be performed according to the preferences, the physical size and the physical characteristics of the user.

In addition, the function of the imaging apparatus 1 can be expanded by mounting, the external monitor, the external recorder, the spare battery, the projector, a separate imaging apparatus 1 or the like on the accessory mounting section 60.

As described above, according to the embodiment of the technology, the position of the shoulder pad 50 can be changed by sliding the slider 130 to any position and by extending the dimension in the longitudinal direction of the imaging apparatus 1. Therefore, stability of the imaging apparatus 1 is improved by moving the center of gravity of the imaging apparatus 1 in the direction of the shoulder pad 50 when the user carries the imaging apparatus 1. The photographer carries the imaging apparatus 1 on the shoulder and the photographing can be performed for a long time while supporting the grip section front of the imaging apparatus 1 in one hand.

In addition, if the photographing lens 20 is the interchangeable lens, the center of gravity of the imaging apparatus 1 is inclined to the front thereof thereby causing imbalance when the imaging apparatus 1 is mounted which is large in size and heavy in weight. In such a case, the dimension in the longitudinal direction of the imaging apparatus 1 is extended by sliding the slider 130 and then the user can use the imaging apparatus 1 in a stable state by being carried on the shoulder.

Since the embodiment includes the second grip section 30 and the first grip section 40, it is possible to achieve both the handy style of being compact and having high maneuverability and the shoulder style of stable photographing with one imaging apparatus 1. In the case of the handy style using the second grip section 30, for example, it is possible to perform handheld photographing for realistic purposes, such as wedding or live music. In addition, in the case of the shoulder style, since the photographing can be stably performed for a long time, it is possible to perform frame layout such as photographing along a scenario, press report, news coverage or the like.

In addition, in order to improve the stability of the imaging apparatus 1 in the related art, a device referred to as a rig is used; however, the present technology does not have to use the rig because the present technology has a mechanism realizing the shoulder style by sliding the slider 130.

### 2. Modification Example

The embodiment of the technology is described in detail; however, the technology is not limited to the above embodiment and various modifications can be performed based on the technical idea of the technology.

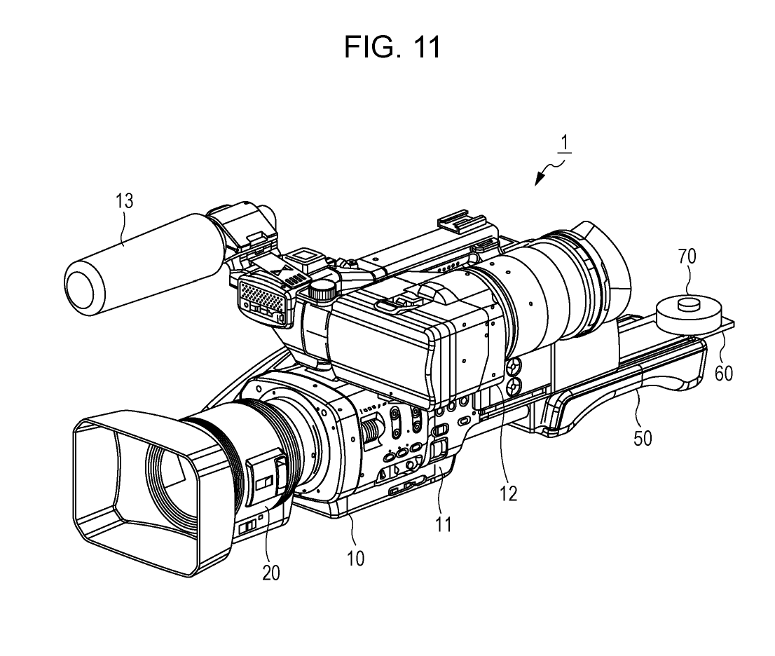

For example, as illustrated in FIG. 11, the accessory mounting section 60 provided on the upper surface of the shoulder pad 50 may be configured to be slid on the shoulder pad 50. Thus, since the mounting position of the accessory is capable of being further changed, for example, when the weight is used as the accessory, more detailed adjustment of the balance can be performed.

In addition, the technology also can take the following configuration:

(1) An imaging apparatus including: an imaging apparatus body; a photographing lens provided on the imaging apparatus body; a shoulder pad which is slidably provided in the imaging apparatus body in a direction opposite to a direction in which the photographing lens is provided; and an accessory mounting section which is provided in the shoulder pad and is capable of mounting an accessory.

(2) The imaging apparatus according to (1), in which the accessory mounting section is provided on a surface opposite to a surface coming into contact with a shoulder of a user in the shoulder pad and is capable of mounting the accessory in a state where the accessory is placed.

(3) The imaging apparatus according to (1) or (2), in which the accessory mounting section is a plurality of fixing holes which fix the accessory and a mounting position of the accessory is capable of being changed by selecting the fixing hole on which the accessory is mounted from the plurality of the fixing holes.

(4) The imaging apparatus according to any one of (1) to (3), further including: a shaft extending from the imaging apparatus body in a direction opposite to a direction in which the photographing lens is mounted, in which the shoulder pad which the shoulder pad is slid along the shaft.

(5) The imaging apparatus according to (4), in which the two or more shafts are provided.

(6) The imaging apparatus according to any one of (1) to (5), further including: a slider capable of sliding on the shoulder pad.

(7) The imaging apparatus according to any one of (1) to (6), further including: a lock mechanism regulating the sliding of the shoulder pad at any position.

(8) The imaging apparatus according to any one of (1) to (7), in which the photographing lens is an interchangeable lens.

(9) The imaging apparatus according to any one of (1) to (8), further including: a first grip section provided on a side surface of the imaging apparatus body and a second grip section provided on an upper surface of the imaging apparatus body.

(10) The imaging apparatus according to any one of (1) to (9), in which the fixing hole is provided substantially at the center of a surface opposite to the surface coming into contact with the shoulder of the user in the shoulder pad.

(11) The imaging apparatus according to any one of (1) to (10), in which the accessory is a weight.

(12) The imaging apparatus according to any one of (1) to (10), in which the accessory is a monitor.

(13) The imaging apparatus according to any one of (1) to (10), in which the accessory is a recorder.

(14) The imaging apparatus according to any one of (1) to (10), in which the accessory is a battery.

(15) The imaging apparatus according to any one of (1) to (10), in which the accessory is a projector.

(16) The imaging apparatus according to any one of (1) to (10), in which the accessory is a separate imaging apparatus.

The present disclosure contains subject matter related to that disclosed in Japanese Priority Patent Application JP 2012-180628 filed in the Japan Patent Office on Aug. 16, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging apparatus comprising:
an imaging apparatus body;
a photographing lens provided on the imaging apparatus body;
a shoulder pad which is slidably provided in the imaging apparatus body in a direction opposite to a direction in which the photographing lens is provided; and
an accessory mounting section which is provided in the shoulder pad and is capable of mounting an accessory.

2. The imaging apparatus according to claim 1,
wherein the accessory mounting section is provided on a surface opposite to a surface coming into contact with a shoulder of a user in the shoulder pad and is capable of mounting the accessory in a state where the accessory is placed.

3. The imaging apparatus according to claim 1,
wherein the accessory mounting section is a plurality of fixing holes which fix the accessory and a mounting position of the accessory is capable of being changed by selecting the fixing hole on which the accessory is mounted from the plurality of the fixing holes.

4. The imaging apparatus according to claim 1, further comprising:
a shaft extending from the imaging apparatus body in a direction opposite to a direction in which the photographing lens is mounted,
wherein the shoulder pad is slid along the shaft.

5. The imaging apparatus according to claim 4,
wherein the two or more shafts are provided.

6. The imaging apparatus according to claim 1, further comprising:
a slider capable of sliding on the shoulder pad.

7. The imaging apparatus according to claim 1, further comprising:
a lock mechanism regulating the sliding of the shoulder pad at any position.

8. The imaging apparatus according to claim 1,
wherein the photographing lens is an interchangeable lens.

9. The imaging apparatus according to claim 1, further comprising:
a first grip section provided on a side surface of the imaging apparatus body and a second grip section provided on an upper surface of the imaging apparatus body.

10. The imaging apparatus according to claim 3,
wherein the fixing hole is provided substantially at the center of a surface opposite to the surface coming into contact with the shoulder of the user in the shoulder pad.

11. The imaging apparatus according to claim 1,
wherein the accessory is a weight.

12. The imaging apparatus according to claim 1,
wherein the accessory is a monitor.

13. The imaging apparatus according to claim 1,
wherein the accessory is a recorder.

14. The imaging apparatus according to claim 1,
wherein the accessory is a battery.

15. The imaging apparatus according to claim 1,
wherein the accessory is a projector.

16. The imaging apparatus according to claim 1,
wherein the accessory is a separate imaging apparatus.
